(19) United States
(12) Patent Application Publication
(10) Pub. No.: US 2017/0355127 A1
(43) Pub. Date: Dec. 14, 2017

(54) METHOD OF IN-MOULD LABELLING PET

(71) Applicant: Tech II, Inc., Springfield, OH (US)

(72) Inventor: Eric Shiffer, North Lewisburg, OH (US)

(21) Appl. No.: 15/591,362

(22) Filed: May 10, 2017

Related U.S. Application Data
(60) Provisional application No. 62/348,424, filed on Jun. 10, 2016.

(51) Int. Cl. B29C 51/16; B32B 27/36; B29C 51/00; B29C 71/04; B32B 27/08; B32B 27/32; B29K 67/00; B29K 105/00; B29L 31/00

(52) U.S. Cl. CPC B29C 51/16; B32B 27/08; B32B 27/36; B29C 51/002; B32B 27/32; B29C 71/04; B29K 2105/256; B29L 2031/712; B29K 2067/003; B29K 2623/12; B32B 2553/00

(57) ABSTRACT

In one embodiment, a method of forming a rigid package includes positioning a label with a plastic outer surface within a mould, positioning a PET sheet over the mould, contacting a first surface portion of the plastic outer surface with a second surface portion of the PET sheet, wherein at least one of the first surface portion and the second surface portion has a surface energy modified by a surface energy treatment, thermoforming the positioned PET sheet in the mould, and direct bonding the first surface portion and the second surface portion.

This application claims the benefit of U.S. Provisional Application No. 62/348,424 filed Jun. 10, 2016, the entire contents of which is herein incorporated by reference.

### FIELD

The disclosure relates to in-mould labelling and more particularly to in-mould labelling of polyethylene terephthalate (PET).

### BACKGROUND

Polyethylene terephthalate (PET) is an environmentally friendly material. PET can be, and is, easily recycled. PET can also be burned since it is composed of carbon, hydrogen, and oxygen, with only trace amounts of catalyst elements, none of which is sulfur. Additionally, PET can be broken down by bacterium.

PET is also a very versatile material. For example, depending upon the particular manufacturing process used, PET can be semi-rigid to rigid. Additionally, PET is very lightweight, functions as both a gas and moisture barrier, exhibits good strength and impact-resistance, and can be formed as a clear package. PET can also be used in thermoforming processes.

All of the foregoing has resulted in the popularity of PET being used as a manufacturing material for rigid packaging in the food, pet food and industrial packaging industries, hence forth know as plastic rigid packaging. One drawback, however, is that PET has traditionally not been useable in an in-mould labelling process. In-mould labelling is a process wherein a pre-printed plastic or plastic laminated paper label is positioned in a mould. A sheet of moldable plastic material is then introduced to the mould at a thermoforming temperature which allows for working of the plastic sheet material. The temperature of the moldable material creates a bond with the label. When the label incorporates the same material as the moldable material, the resulting final product includes a fully integrated label. Additional details of one form of in-mould labelling are disclosed in U.S. Pat. No. 8,714,962, the contents of which are herein incorporated by reference.

In-mould labelling, in addition to providing an integrated label, reduces the total costs of the product by reducing the number of manufacturing steps. Accordingly, it is useful to incorporate in-mould labelling for plastic rigid packaging. This has not been possible, however, when forming food packages from PET. As an initial matter, PET sheets are traditionally coated with a thin layer of silicon to protect the PET. This layer of silicon inhibits bonding of a PET sheet with a plastic substrate label. Even if the silicon layer is removed, PET exhibits a low surface energy. Thus, even at high temperatures two pieces of PET or two different plastic materials, one of which is PET, do not form the desired bond. Consequently, PET, polypropylene (PP) or polyethylene (PE) labels tend to detach from the PET package.

What is desired, therefore, is a process of producing an enhanced bond between a PET portion and a plastic portion such as a plastic label (e.g. PET or PP) and a PET package. It would be further beneficial if the process was useful with PET rigid packaging. A further benefit would be the ability to provide an enhanced bond between a plastic label and a PET package which does not adversely affect clarity of the PET package.

### SUMMARY

In one embodiment a method of forming a rigid package includes positioning a label with a plastic outer surface within a mould, positioning a PET sheet over the mould, contacting a first surface portion of the plastic outer surface with a second surface portion of the PET sheet, wherein at least one of the first surface portion and the second surface portion has a surface energy modified by a surface energy treatment, thermoforming the positioned PET sheet in the mould, and direct bonding the first surface portion and the second surface portion.

In one or more embodiments, the at least one of the first surface portion and the second surface portion having a modified surface energy is modified by performing a plasma treatment of the at least one of the first surface portion and the second surface portion.

In one or more embodiments, performing the plasma treatment of the at least one of the first surface portion and the second surface portion includes exposing the at least one of the first surface portion and the second surface portion to an atmospheric pressure plasma stream.

In one or more embodiments, exposing the at least one of the first surface portion and the second surface portion to an atmospheric pressure plasma stream includes exposing the first surface portion to the plasma stream prior to positioning the first surface portion within the mould.

In one or more embodiments, positioning the label with the plastic outer surface within the mould includes positioning a label with a plastic outer surface comprising polypropylene (PP) within the mould.

In one or more embodiments, both the first surface portion and the second surface portion have surface energies modified by a surface energy treatment.

In one or more embodiments, positioning the label with the plastic outer surface within the mould includes positioning a label with a plastic outer surface comprising polyethylene terephthalate (PET) within the mould.

In one or more embodiments, positioning a label within the mould includes positioning a multiple layer label with a plastic outer surface within the mould.

In one or more embodiments, performing the plasma treatment of the at least one of the first surface portion and the second surface portion includes forming plasma from compressed air. In one or more embodiments high energy RF is used to generate the plasma.

In one embodiment, a rigid package includes a polyethylene terephthalate (PET) body portion, and a label including a plastic outer surface integrated with the PET body portion by direct bonding.

In one or more embodiments the label is a multiple layer label.

In one or more embodiments, the plastic outer surface includes polypropylene (PP).

In one or more embodiments, the plastic outer surface includes polyethylene terephthalate (PET).

In one embodiment, a method of forming a rigid package includes positioning a first surface portion of polyethylene terephthalate (PET) within a mould, positioning a second surface portion of plastic within the mould, bringing the first surface portion and the second surface portion into contact, wherein the first surface portion has a surface energy modified by a surface energy treatment, and directly bonding the first surface portion and the second surface portion while thermoforming the first surface portion and the second surface portion.

In one or more embodiments, the first surface portion surface energy is modified by performing a plasma treatment of the first surface portion.

In one or more embodiments, performing the plasma treatment of the first surface portion includes exposing the first surface portion to an atmospheric pressure plasma stream.

In one or more embodiments, performing the plasma treatment of the first surface portion includes exposing the first surface portion to the plasma stream prior to positioning the first surface portion within the mould.

In one or more embodiments, performing the plasma treatment of the first surface portion includes exposing the first surface portion to the plasma stream after positioning the first surface portion within the mould.

In one or more embodiments, positioning the first surface portion of PET within the mould includes positioning a first surface portion of PET sheet within the mould.

In one or more embodiments, positioning the second surface portion of plastic within the mould includes positioning a label with an outer surface including polypropylene (PP) within the mould, wherein the second surface portion is a portion of the outer surface.

In one or more embodiments positioning a first surface portion of PET within the mould includes positioning a multilayer label within the mould.

### BRIEF DESCRIPTION OF THE DRAWINGS

The accompanying drawings illustrate various embodiments of the disclosure and together with a description serve to explain the principles of the disclosure.

FIG. 1 depicts a top perspective view of a PET rigid package with an in-mould formed PP label;

FIG. 2 depicts an in-mould labelling process for forming a rigid package from a PET sheet and a PP label;

FIG. 3 depicts a schematic showing how a contact angle is determined;

FIG. 4 depicts a contact angle formed by an untreated PET sheet;

FIGS. 5-10 depict contact angles formed on various PET sheets which have a surface modified to improve wettability of the PET sheet;

FIGS. 11-14 depict the PET sheets of FIGS. 5, 6, 7, and 10, respectively, twenty-four hours after a surface energy treatment;

FIG. 15 depicts a schematic side plan view of a thermoforming system which in one embodiment is used to directly bond a label to the body of a plastic container; and

FIG. 16 depicts a schematic front view of the thermoforming system of FIG. 15.

Corresponding reference characters indicate corresponding parts throughout the several views. Like reference characters indicate like parts throughout the several views.

### DETAILED DESCRIPTION OF THE DISCLOSURE

While the packages and methods described herein are susceptible to various modifications and alternative forms, specific embodiments thereof have been shown by way of example in the drawings and will herein be described in detail. It should be understood, however, that there is no intent to limit the packages and methods to the particular forms disclosed. On the contrary, the intention is to cover all modifications, equivalents, and alternatives falling within the spirit and scope of the disclosure.

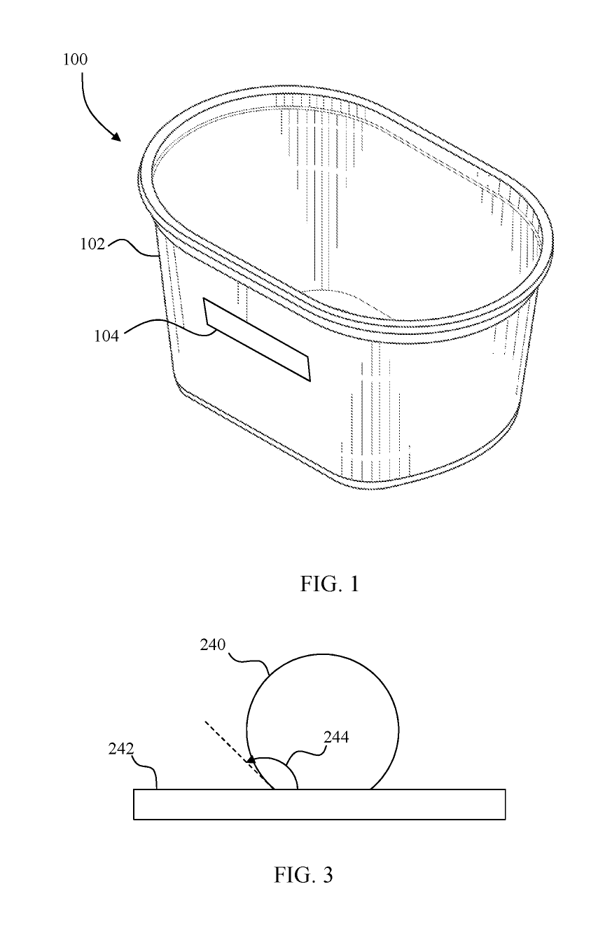

Referring to FIG. 1, rigid package 100 is shown. The rigid package 100 includes a body portion 102 and a label 104. The body portion 102 is formed from polyethylene terephthalate (PET). The plastic label 104 which in one embodiment is formed from PP is integrated into the body portion 102 in that the label 104 is attached to the body portion 102 by a bond resulting from an in-mould labelling process.

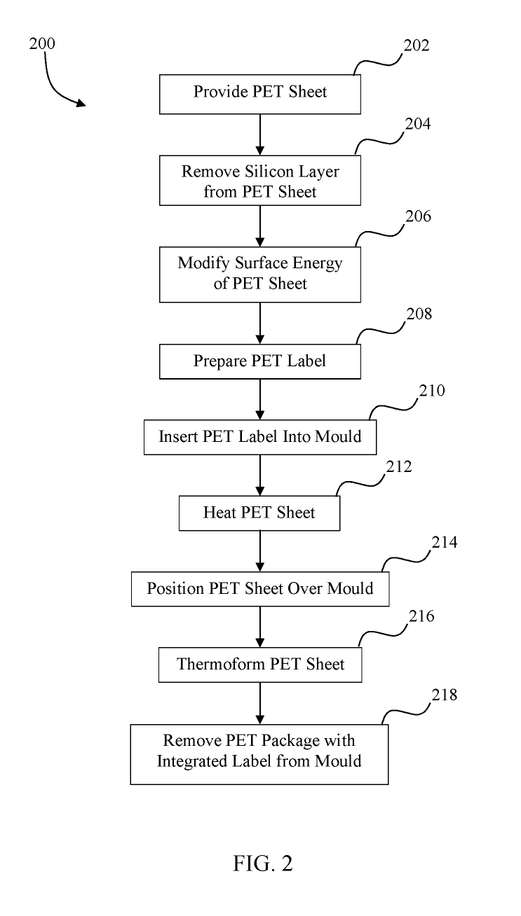

One embodiment of an in-mould labelling process 200 used to form the plastic rigid package 100 is described in reference to FIG. 2. The in-mould labelling process begins at block 202 with the provision of a PET sheet. As discussed above, PET sheets are frequently provided with a silicon protective layer. Accordingly, at block 204 any such silicon layer is removed from the PET sheet using a desired process such as by burning the silicon layer off of the sheet.

The surface energy of one side of the PET sheet is then modified (block 206). As will be discussed in further detail below, modification of the surface energy of the PET sheet results in an increased wettability of the sheet which provides for integration of a plastic label such as PP into a PET package during in-mould thermoforming.

At block 208, a plastic label is prepared. In various embodiments, the plastic label is prepared prior to, after, or contemporaneously with the preparation of the PET sheet as discussed above with respect to blocks 204 and 206. In some embodiments, the plastic label includes a PET outer layer prepared by removing the silicon layer and modifying the surface energy of the plastic label. In some embodiments, only silicon layer removal is incorporated. A “label” as that term is used herein is a component which is typically pre-printed, and includes one or more layers of a commonly used label polymer substrate, typically blown thin-film, for use in the label printing industry. In different embodiments, the outer layer of the label is a plastic such as PP or PET. An “outer surface” of a label is defined as the surface which is not in contact with the mould when he label is positioned within the mould. Accordingly, preparation of the label may include the formation of a “sandwich” label wherein the layer which eventually contacts the PET sheet is made from a plastic such as PP or PET while other layers are formed from PET, PP and/or other materials.

Once the label is prepared, the label is inserted into the mould (block 210) with a plastic surface exposed. Typically the exposed surface is a non-printed surface. The mould can be incorporated into any desired thermoforming device. In one embodiment, the thermoforming device is vacuum, pressure, plug assist or any combination, such as a FT4K Low Flex Thermoformer commercially available from TSL Inc., in Yakima Washington. The PET sheet is then heated (block 212) and positioned over the mould (block 214) with the side of the PET sheet with the modified surface energy facing the mould with the label therein.

At block 216 the PET sheet is thermoformed such as by forming a vacuum within the mould thereby drawing the PET sheet into the mould. As the PET sheet is drawn into the mould, the side of the PET sheet with the modified surface energy is pressed against the exposed outer plastic surface of the label as the PET package is formed. Because the surface energy of the PET sheet has been modified, the label is integrated or “direct bonded” into the PET package. “Direct bonding” is bonding that does not require an adhesive or other material to form a bond between two surfaces. The PET package with the integrated PET label is then cooled and removed from the mould (block 218).

The process 200 in different applications is modified for the particular application. By way of example, while the surface energy of the PET sheet is modified in the process 200, in some embodiments the surface energy of a layer of the label which eventually contacts the PET sheet is modified in a similar fashion in addition to, or as an alternative to, modification of the surface energy of the PET sheet. Modification of the surface energy of the PET (sheet and/or label) in some embodiments is effected while the label and/or sheet is located within the mould.

In further embodiments, one or more of the steps of the process 200 are combined, performed in a different order, or eliminated. By way of example, in some embodiments heating of the PET sheet occurs prior to modification of the surface energy of the PET sheet. In some embodiments, the PET sheet is provided without a silicon layer. Accordingly, the step of removing the silicon layer may be omitted.

Surface modification of the PET is accomplished in one embodiment by subjecting the PET to a Plasma Deposition, Reactive Ion Etch or other similar Gas Treatment referred to herein as a “surface energy treatment”. The surface energy treatment affects the surface energy by way of one or more of an ionic etch, deposition of non-adhesives such as atmospheric constituents (including atmospheric contaminates) and/or added non-adhesive products to obtain desired reaction and subsequent surface energy. The surface treatment can be controlled to provide the desired surface modification. This was verified using a reactive ion etch machine commercially available from Trion Technology, Inc. of Clearwater Florida. The results of the etching were verified using a procedure based upon ASTMD5725-99.

The modified ASTMD procedure begins with placement of the substrate to be tested in an optical comparator. In the following examples, a Deitronic MPC-5 Optical Comparator was used. Once the substrate is properly positioned and flattened, a 10 μl syringe is used to deposit a 1 μl drop of water onto the substrate. The Optical

Comparator is then used to measure the contact angle of the water drop as explained with reference to FIG. 3. In FIG. 3, a drop of water 240 has been positioned on a surface 242. Based upon the surface energy or wettability of the surface 242, a contact angle 244 is formed between the surface 242 and the water drop 240. In general, as the surface energy increases, the height of the water drop decreases and the diameter of the surface contact of the droplet increases resulting in a reduction of the contact angle.

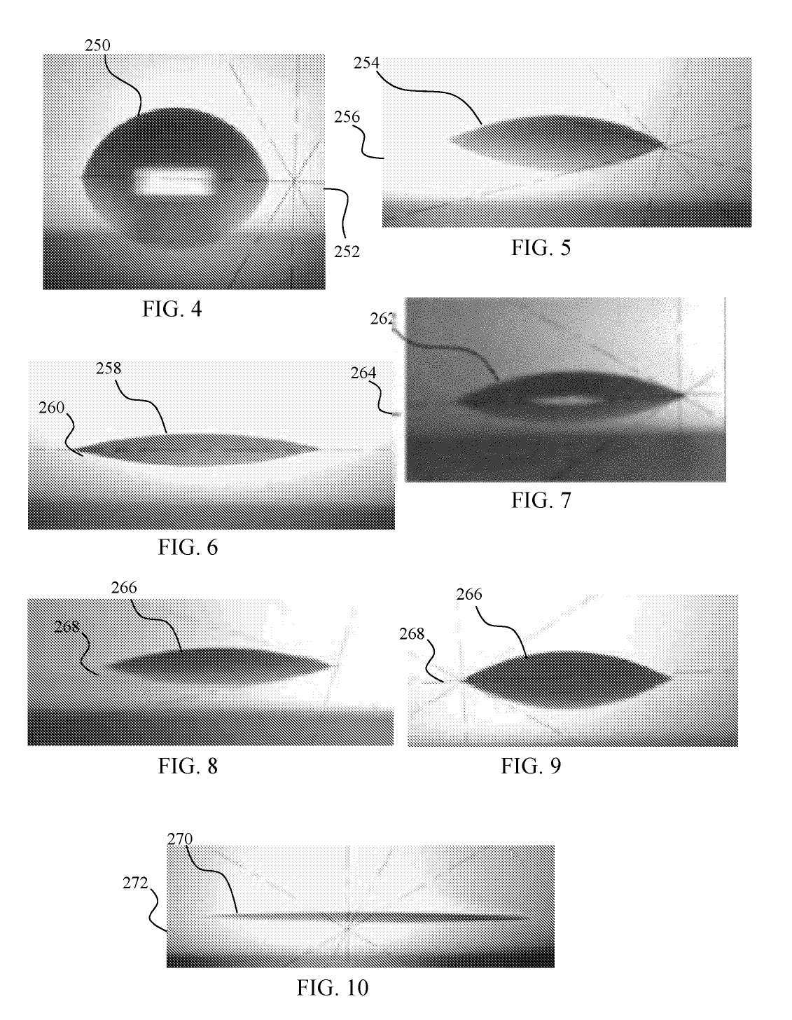

FIG. 4 depicts a 1 μl drop of water 250 positioned on a 3″ square PET sheet 252 with no surface modification. The contact angle is shown to be about 77°.

FIG. 5 depicts a 1 μl drop of water 254 positioned on a 3″ square PET sheet 256 which was etched with an oxygen flow of 125 cubic centimeters (ccm) with a reactive ion etch power of 100 W at 200 mTorr for two minutes. The resulting contact angle is shown to be about 23°.

FIG. 6 depicts a 1 μl drop of water 258 positioned on a 3″ square PET sheet 260 which was etched with an oxygen flow of 248.3 ccm with a reactive ion etch power of 200 W at 200 mTorr for two minutes. The resulting contact angle is shown to be about 7°.

FIG. 7 depicts a 1 μl drop of water 262 positioned on a 3″ square PET sheet 264 which was etched with an oxygen flow of 200 ccm with a reactive ion etch power of 150 W at 200 mTorr for two minutes. The resulting contact angle is shown to be about 24°.

FIG. 8 depicts a 1 μl drop of water 266 positioned on a 3″ square PET sheet 268 which was etched with an oxygen flow of 248.3 ccm with a reactive ion etch power of 200 W at 200 mTorr. The chamber was maintained at 33° C. The resulting contact angle is shown to be about 20°.

FIG. 9 depicts a 1 μl drop of water 266 positioned on a 3″ square PET sheet 268 which was etched with an oxygen flow of 248.3 ccm with a reactive ion etch power of 200 W at 200 mTorr for one minute. The resulting contact angle is shown to be about 30°.

FIG. 10 depicts a 1 μl drop of water 270 positioned on a 3″ square PET sheet 272 which was etched with an oxygen flow of 248.3 ccm with a reactive ion etch power of 200 W at 200 mTorr for three minutes. The chamber was maintained at 33° C. The resulting contact angle is shown to be about 5°.

FIGS. 4-10 establish that surface modification of PET resulted in a significant increase in surface energy. The increase was exemplified by a reduction in the contact angle of between 63-88% from an untreated PET surface. The amount of increase in surface energy depended primarily on gas concentration, surface energy treatment time, and RIE wave flow. Specifically, an increase in any one of the gas concentration, surface energy treatment time, and RIE wave flow resulted in an increase in the amount of surface energy change. Increased surface energy also resulted from an increase in etch time. Variations in pressure within the chamber did not significantly affect the surface energy.

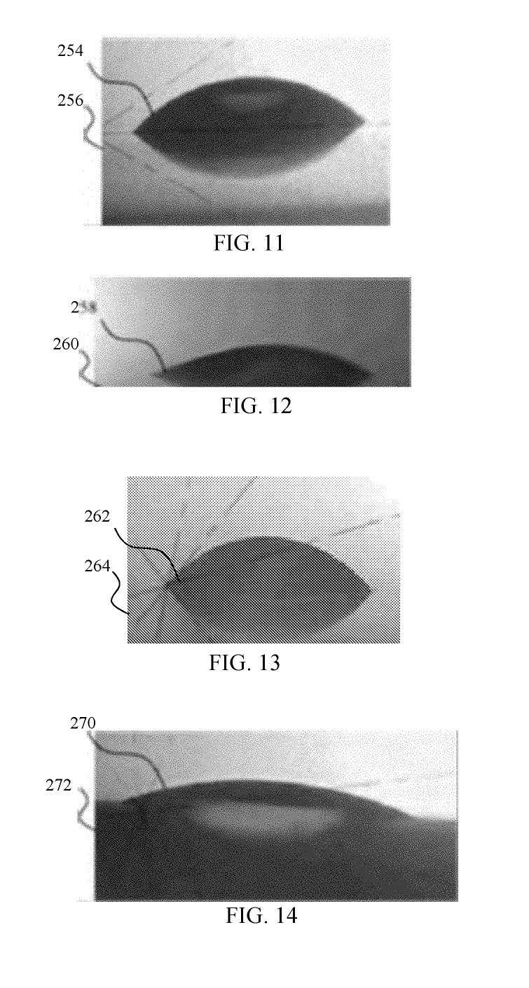

The PET surfaces of FIGS. 5, 6, 7, and 10 were retested 24 hours after the surface energy treatment. The results are depicted in FIGS. 11-14. FIGS. 11, 12, 13, and 14 depict the water and surfaces of FIGS. 5, 6, 7, and 10, respectively. FIGS. 11-14 indicate that the surface energy has decreased from the surface energy immediately after surface energy treatment since the variation in contact angle from the control sample of FIG. 4 is increased between 55-76% compared to the immediate results of 63-83%.

In some embodiments, the surface energy treatment of PET is performed within a vacuum chamber. Use of a vacuum chamber allows the atmosphere to be closely controlled. Moreover, formation of some plasma is more easily accomplished within a vacuum. In other embodiments, an open air plasma surface energy treatment is used.

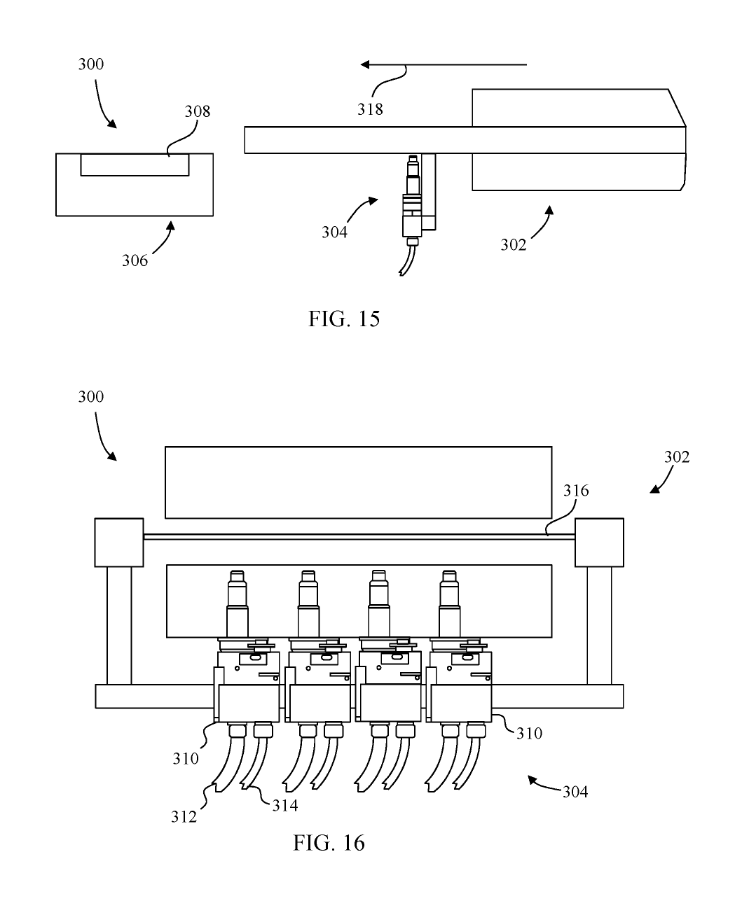

By way of example, FIGS. 15 and 16 depict a thermoforming system 300 which is used in some embodiments to directly bond a label to a rigid package body. The thermoforming system 300 includes a thermoformer heat tunnel 302, a plasma treatment station 304, and a forming station 306. In one embodiment the system described in U.S. Pat. No. 8,714,962 is used as the forming station 306. The forming station 306 includes a mould 308 configured to form one or more rigid packages.

The plasma treatment station 304 in this embodiment includes four nozzle assemblies 310. Each nozzle assembly 310 is fed by a gas line 312 and powered by a power line 314. The plasma may be formed in any desired manner such as by using high energy RF, high voltage discharge, microwave, etc. The nozzle assemblies in one embodiment are an Atmospheric Plasma Treatment Tool model number RD1004, commercially available from Plasmatreat USA Inc., of Elgin, Ill., which generates a cold plasma using a desired gas or gas mixture such as compressed air. In general, plasma is generated in the nozzle assembly jet's reaction chamber, forming a discharge that exits the jet nozzle at high velocity onto the PET sheet. The plasma treatment station 304 is thus not maintained in a vacuum. Rather, the plasma treatment station 304 emits an atmospheric pressure plasma stream. An “atmospheric pressure plasma stream” is defined herein to mean plasma emitted into an area of atmospheric pressure.

While the plasma treatment station 304 depicted in FIGS. 15-16 includes four nozzle assemblies 304, in other embodiments more or fewer nozzle assemblies are provided. Moreover, while the nozzles may be configured to treat substantially the entire sheet, in other embodiments only locations which are to be bonded to a label are treated. Furthermore, while in the embodiment of FIGS. 15 and 16 the sheet 316 is treated, in other embodiments the sheet 316 is replaced with a label such as the label 104 and only the label 104 is treated. In further embodiments, both the label and the sheet are treated.

In operation, a label such as the label 104 is prepared and positioned within the mould 308 in the forming station 306. In one embodiment, the label is a single layer plastic label such as a PP or PET label. In another embodiment, the label is a multiple layer label with an outer surface layer of plastic such as PP or PET. In at least one embodiment, the surface energy of the outer PP or PET surface is not modified. In another embodiment, the outer PP or PET surface is modified either before or after positioning the label within the mould.

The sheet 316 which in one embodiment is a PET sheet and is preheated within the thermoformer heat tunnel 302 as it travels in the direction of the arrow 318 of FIG. 15. The surface energy of the lower surface of the sheet 316 is then modified by a plasma treatment from the plasma treatment station 304. In one embodiment, surface treatment time is about 4.5 seconds with a nozzle assembly 304 positioned 0.5 inches away from the PET surface. In some embodiments wherein the label is plasma treated, plasma treatment of the sheet 316 is omitted. In some embodiments, the plasma treatment occurs prior to heating the sheet 316 within the thermoformer heat tunnel 302.

The sheet 316 is then positioned over the mould 308 and subsequently positioned within the mould such that a portion of the sheet 316 which has been surface treated contacts the label. Thus, in one embodiment a surface treated surface portion of a PET sheet is placed in contact with a plastic surface portion of the label (such PP or PET), with at least one of the two surface portions exhibiting a modified surface energy resulting from a plasma treatment. The heat energy within the heated sheet 316 causes a direct bond to form between the two surface portions without the need for any adhesive as the forming station 306 thermoforms the sheet 316 into a desired shape. The fully integrated package and label is then cooled and removed from the mould.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected. By way of example, other gases may be used to etch the surface of the PET.

Additionally, other surface modification techniques can be used such as localized modification or surface roughness. Furthermore, while surface modification of PET to allow for in-mould labelling has been discussed, the use of the above described surface modification techniques may also be applied to other labelling processes. For example, PET surfaces may be modified such as by the use of reactive ion etching to allow for the use of inks such as UV curable inks.

1. A method of forming a rigid package, comprising:
positioning a label with a plastic outer surface within a mould;
positioning a PET sheet over the mould;
contacting a first surface portion of the plastic outer surface with a second surface portion of the PET sheet, wherein at least one of the first surface portion and the second surface portion has a surface energy modified by a surface energy treatment;
thermoforming the positioned PET sheet in the mould; and
direct bonding the first surface portion and the second surface portion.

2. The method of claim 1, wherein the at least one of the first surface portion and the second surface portion having a modified surface energy is modified by:
performing a plasma treatment of the at least one of the first surface portion and the second surface portion.

3. The method of claim 2, wherein performing the plasma treatment of the at least one of the first surface portion and the second surface portion comprises:
exposing the at least one of the first surface portion and the second surface portion to an atmospheric pressure plasma stream.

4. The method of claim 3, wherein exposing the at least one of the first surface portion and the second surface portion to an atmospheric pressure plasma stream comprises:
exposing the first surface portion to the plasma stream prior to positioning the first surface portion within the mould.

5. The method of claim 4, wherein positioning the label with the plastic outer surface within the mould comprises:
positioning a label with a plastic outer surface comprising polypropylene (PP) within the mould.

6. The method of claim 5, wherein both the first surface portion and the second surface portion have surface energies modified by a surface energy treatment.

7. The method of claim 3, wherein positioning the label with the plastic outer surface within the mould comprises:
positioning a label with a plastic outer surface comprising polyethylene terephthalate (PET) within the mould.

8. The method of claim 3, wherein positioning a label within the mould comprises:
positioning a multiple layer label with a plastic outer surface within the mould.

9. The method of claim 3, wherein performing the plasma treatment of the at least one of the first surface portion and the second surface portion comprises:
forming plasma from compressed air.

10. A rigid package, comprising:
a polyethylene terephthalate (PET) body portion; and
a label including a plastic outer surface integrated with the PET body portion by direct bonding.

11. The package of claim 10, wherein the label is a multiple layer label.

12. The package of claim 10, wherein the plastic outer surface comprises polypropylene (PP).

13. The package of claim 10, wherein the plastic outer surface comprises polyethylene terephthalate (PET).

14. A method of forming a rigid package, comprising:
positioning a first surface portion of polyethylene terephthalate (PET) within a mould;
positioning a second surface portion of plastic within the mould;
bringing the first surface portion and the second surface portion into contact, wherein the first surface portion has a surface energy modified by a surface energy treatment; and
directly bonding the first surface portion and the second surface portion while thermoforming the first surface portion and the second surface portion.

15. The method of claim 14, wherein the first surface portion surface energy is modified by:
performing a plasma treatment of the first surface portion.

16. The method of claim 15, wherein performing the plasma treatment of the first surface portion comprises:
exposing the first surface portion to an atmospheric pressure plasma stream.

17. The method of claim 16, wherein performing the plasma treatment of the first surface portion comprises:
exposing the first surface portion to the plasma stream prior to positioning the first surface portion within the mould.

18. The method of claim 16, wherein performing the plasma treatment of the first surface portion comprises:
exposing the first surface portion to the plasma stream after positioning the first surface portion within the mould.

19. The method of claim 16, wherein positioning the first surface portion of PET within the mould comprises:
positioning a first surface portion of PET sheet within the mould.

20. The method of claim 16, wherein positioning the second surface portion of plastic within the mould comprises:
positioning a label with an outer surface comprising polypropylene (PP) within the mould, wherein the second surface portion is a portion of the outer surface.
